(19) United States
(12) Patent Application Publication
(10) Pub. No.: US 2015/0339591 A1
(43) Pub. Date: Nov. 26, 2015

(54) Collegial Activity Learning Between Heterogeneous Sensors

(71) Applicant: Washington State University, Office of Commercialization, Pullman, WA (US)

(72) Inventors: Diane J. Cook, Pullman, WA (US); Kyle Feuz, Pullman, WA (US)

(21) Appl. No.: 14/720,078

(22) Filed: May 22, 2015

Related U.S. Application Data
(60) Provisional application No. 62/002,702, filed on May 23, 2014.

(51) Int. Cl. G06N 99/00

(52) U.S. Cl. CPC G06N 99/005

(57) ABSTRACT

Unlabeled and labeled sensor data is received from one or more source views. Unlabeled, and optionally labeled, sensor data is received from a target view. The received sensor data is used to train activity recognition classifiers for each of the source views and the target view. The sources and the target each include one or more sensors, which may vary in modality from one source or target to another source or target.

### RELATED APPLICATION

This application claims the benefit of U.S. Provisional Application No. 62/002,702, filed May 23, 2014, which is hereby incorporated by reference.

### BACKGROUND

Smart environments are becoming more common, and include homes, apartments, workplaces, and other types of spaces that are equipped with environmental sensors, such as, for example, motion sensors, light sensors, temperature sensors, door sensors, and so on. In addition, other devices are continually being developed that may also include various types of sensors such as, for example, accelerometers, cameras, or microphones. These other devices may include, for example, wearable sensors, smart phones, and smart vehicles. Sensor data can be analyzed to determine various user activities, and can support ubiquitous computing applications including, for example, applications to support medical monitoring, energy efficiency, assistance for disabled individuals, monitoring of aging individuals, or any of a wide range of medical, social, or ecological issues. In other words, data collected through sensors can be used to detect and identify various types of activities that individual users are performing, this information can be used to monitor individuals or may be used to provide context-aware services to improve energy efficiency, safety, and so on.

Before sensor data can be used to identify specific activities, a computer system associated with a set of sensors must become aware of relationships among various types of sensor data and specific activities. Because the floor plan, layout of sensors, number of residents, type of residents, and other factors can vary significantly from one smart environment to another, and because the number of types of sensors implemented as part of a particular environment or device varies greatly across different environments and devices, activity recognition systems are typically designed to support specific types of sensors. For example, a smart phone may be configured to perform activity recognition based on data collected from sensors including, but not limited to, accelerometers, gyrosocpes, barometers, a camera, a microphone, and a global positioning system (GPS). Similarly, a smart environment may be configured to perform activity recognition based on data collected from, for example, stationary sensors including, but not limited to, motion sensors (e g , infrared motion sensors), door sensors, temperature sensors, light sensors, humidity sensors, gas sensors, and electricity consumption sensors. Other sensor platforms may also include any combination of other sensors including, but not limited to, depth cameras, microphone arrays, and radio-frequency identification (RFID) sensors.

Furthermore, setup of an activity recognition system has typically included a time-intensive learning process for each environment or device from which sensor data is to be collected. The learning process has typically included manually labeling data collected from sensors to enable a computing system associated with a set of sensors to learn relationships between sensor readings and specific activities. This learning process represents an excessive time investment and redundant computational effort.

### SUMMARY

Heterogeneous multi-view transfer learning algorithms identify labeled and unlabeled data from one or more source views and identify unlabeled data from a target view. If it is available, labeled data for the target view can also be utilized. Each source view and the target view include one or more sensors that generate sensor event data. The sensors associated with one view (source or target) may be very different from the sensors associated with another view. Whatever labeled data is available is used to train an initial activity recognition classifier. The labeled data, the unlabeled data, and the initial activity recognition classifier then form the basis to train an activity recognition classifier for each of the one or more source views and for the target view.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The various features described herein may, for instance, refer to device(s), system(s), method(s), and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a pictorial diagram of an example environment in which collegial activity learning between heterogeneous sensors may be implemented.

FIG. 2 is a block diagram that illustrates an example of informed multi-view learning.

FIG. 3 is a flow diagram of an example process for transferring activity recognition information from one or more source views to a target view based on a Co-Training informed multi-view learning algorithm.

FIG. 4 is a flow diagram of an example process for transferring activity recognition information from one or more source views to a target view based on a Co-EM informed multi-view learning algorithm.

FIG. 5 is a block diagram that illustrates an example of uninformed multi-view learning.

FIG. 6 is a flow diagram of an example process for transferring activity recognition information from one or more source views to a target view based on a Manifold Alignment uninformed multi-view learning algorithm.

FIG. 7 is a flow diagram of an example process for transferring activity recognition information from one or more source views to a target view based on a teacher-learner uninformed multi-view learning algorithm.

FIG. 8 is a flow diagram of an example process for transferring activity recognition information from one or more source views to a target view based on a personalized ecosystem (PECO) multi-view learning algorithm.

FIG. 9 is a block diagram that illustrates select components of an example computing device for implementing collegial activity learning between heterogeneous sensors.

### DETAILED DESCRIPTION

Learning and understanding observed activities is at the center of many fields of study. An individual's activities affect that individual, those around him, society, and the environment. The increased development of sensors and network design has made it possible to implement automated activity recognition based on sensor data. A personalized activity recognition ecosystem may include, for example, a smart home, a smart phone, a smart vehicle, any number of wearable sensors, and so on, and the various components of the ecosystem may all work together to perform activity recognition and to provide various benefits based on the activity recognition.

Within the described personalized activity recognition ecosystem, the different sensor platforms participate in collegial activity learning to transfer learning from one sensor platform to another, for example, to support the addition of a new sensor platform within an ecosystem and to use knowledge from one sensor platform to boost the activity recognition performance of another sensor platform.

Example Environment

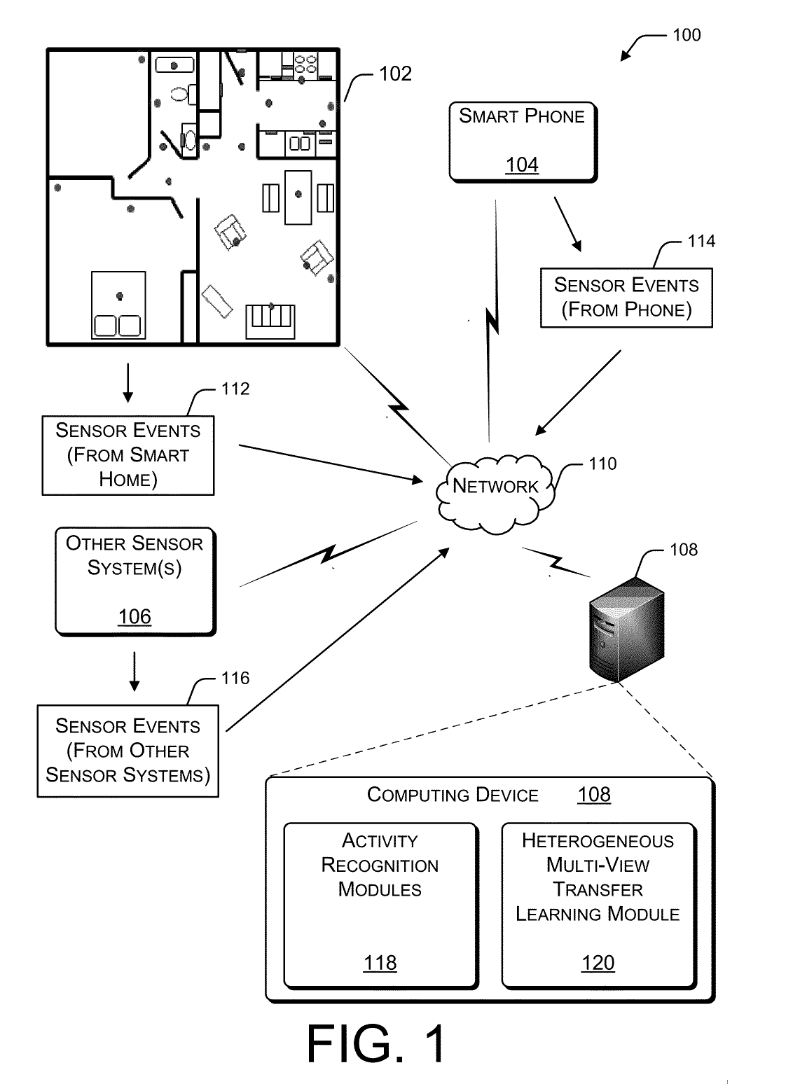

FIG. 1 illustrates an example environment 100 implementing collegial activity learning between heterogeneous sensors. In the illustrated example, a personalized activity recognition ecosystem includes a smart home 102, a smart phone 104 equipped with one or more sensors, and any number of other sensor systems 106 (e.g., one or more wearable sensors).

Sensor events from each of the sensor modalities are transmitted to a computing device 108, for example, over a network 110, which represents one or more networks, which may be any type of wired or wireless network. For example, as illustrated in FIG. 1, sensor events 112 are communicated from sensors in smart home 102 to computing device 108 over network 110; sensor events 114 are communicated from sensors in smart phone 104 to computing device 108 over network 110; and sensor events 116 are communicated from other sensor system(s) 106 to computing device 108 over network 110.

Computing device 108 includes activity recognition modules 118 and heterogeneous multi-view transfer learning module 120. Activity recognition modules 118 represent any of a variety of activity recognition models configured to perform activity recognition based on received sensor events. For example, a first activity recognition model may be implemented to recognize activities based on sensor events 112 received from the smart home 102 sensors. Another activity recognition model may be implemented to recognize activities based on sensor events 114 received from smart phone 104. Still further activity recognition models may be implemented to recognize activities based on other received sensor events 116.

Activity recognition refers to labeling activities from a sensor-based perception of a user within an environment. For example, within a smart home 102, sensor events 112 may be recorded as a user moves throughout the environment, triggering various environmental sensors. As another example, a smart phone 104 may record sensor events 114 based on, for example, accelerometer data, gyroscope data, barometer data, video data, audio data, and user interactions with phone applications such as calendars. According to an activity recognition algorithm, a sequence of sensor events, or sensor readings, x =<e₁,e₂, . . . eₙ>, is mapped onto a value from a set of predefined activity labels, y ∈ Y. A supervised machine learning technique can be used to enable the activity recognition algorithm to learn a function that maps a feature vector describing the event sequence, X, onto an activity label, h:X→Y.

The sequential nature of the sensor data, the need to partition the sensor data into distinct instances, the imbalance in class distributions, and the common overlapping of activity classes are characteristics of activity recognition that pose challenges for machine learning techniques. Furthermore, in the described scenario, which includes heterogeneous sensors (e.g., motion sensors in a smart home, wearable sensors, and an accelerometer in a smart phone), the type of raw sensor data and the formats of the resulting feature vectors can vary significantly from one sensor platform to another. Additional data processing to account for these challenges can include, for example, preprocessing sensor data, dividing the sensor data into subsequences, and converting sensor data subsequences into feature vectors.

In an example implementation, activity recognition modules 118 perform activity recognition in real time based on streaming data. According to this algorithm, a sequence of the k most recent sensor events is mapped to the activity label that corresponds to the last (most recent) event in the sequence, with the sensor events preceding the last event providing a context for the last event.

Sensors can be classified as discrete event sensors or sampling-based sensors, depending on how and when a sensor records an event. For example, discrete event sensors report an event only when there is a state change (i.e., a motion sensor reports an “on” event when nearby motion is detected, and reports an “off” event when the motion is no longer detected). In an example implementation, a sensor event reported from a discrete event sensor includes the time of day, day of the week, and the identifier of the sensor generating the reading. In contrast, sampling-based sensors record sensor events at predefined time intervals (e.g., an event is recorded every second). As a result, many statistical and spectral features can be used to describe the event values over a window of time, including, for example, a minimum, a maximum, an average, zero crossings, skewness, kurtosis, and auto-correlation. To provide consistency between discrete event sensor events sampling-based sensor events, data from discrete event sensors can be made to emulate data from sampling-based sensors, for example, by duplicating a current state at a desired frequency until a new discrete event sensor event is received.

In an example implementation, activity recognition modules 118 receive the sensor readings, and generate feature vectors based on the received sensor data. Activity recognition modules 118 perform activity recognition based on the feature vectors, which may then be labeled based on an identified activity. Activity recognition modules 118 may employ various techniques for activity recognition, including, for example, decision trees, naï Bayes classifiers, hidden Markov models, conditional random fields, support vector machines, k nearest neighbor, support vector machines, and ensemble methods.

In the illustrated example, an activity recognition model for the smart home 102 may initially be trained based on data collected from sensors installed within the smart home 102. Alternatively, the smart home 102 may be trained based on data from another smart home.

When smart phone 104 is added to the personalized activity recognition ecosystem, omni-directional inter-device multi-view learning techniques (i.e., collegial learning) are implemented to allow the existing smart home 102 to act as a teacher for the smart phone 104. Furthermore, the collegial learning described herein improves the performance of the smart home activity recognition based on data received from the smart phone 104.

For example, a smart home 102 includes multiple sensors to monitor motion, temperature, and door use. Sensor data is collected, annotated with ground truth activity labels, and used to train an activity classifier for the smart home. At some later time, the resident decides they want to train sensors of the smart phone 104 to recognize the same activities recognized within the smart home 102. In this way, the phone can continue to monitor activities that are performed out in the community and can update the original model when the resident returns home. Whenever the smart phone is located inside the smart home, both sensing platforms will collect data while activities are performed, resulting in a multi-view problem where the smart home sensor data represents one view and the smart phone sensor data represents a second view.

### Transfer Learning for Activity Recognition

In order to share learned activity information between heterogeneous sensor platforms, new transfer learning approaches are considered. Transfer learning within the field of machine learning is described using a variety of terminology. To avoid confusion, the following terms are defined, as used herein: “domain,” “task,” “transfer learning,” and “heterogeneous transfer learning.”

As used herein, a “domain” D is a two-tuple (X, P(X)). X is the feature space of D and P(X) is the marginal distribution where X ={x₁, . . . xₙ} ∈ X.

As used herein, a “task” T is a two-tuple (Y, f ( )) for some given domain D. Y is the label space of D and f ( )is an objective predictive function for D. f ( )is sometimes written as a conditional probability distribution P(y|x). f ( )is not given, but can be learned from the tranining data.

As used herein, in the context of activity recognition as described above, the domain is defined by the feature space representing the k most recent sensor events and a marginal probability distribution over all possible feature values. The task is composed of a label space, y, which consist of the set of labels for activites of interest, and a conditional probability distribution consisting of the probability of assigning a label yᵢ ∈ y given the observed instance x ∈ X.

As used herein, the definition of “transfer learning” allows for multiple source domains. Given a set of source domains DS =Dₛ_{₁}, . . . , Dₛ_{ₙ} where n>0, a target domain Dₜ, a set of source tasks TS=Tₛ_{₁}, . . . ,Tₛ_{ₙ} where Tₛ_{ᵢ} ∈ TS corresponds with Dₛ_{ᵢ} ∈ DS, and a target task Tₜ which corresponds to Dₜ, transfer learning improves the learning of the target predictive function fₜ ( ) in Dₜ, where Dₜ ∉ DS and Tₜ ∉ TS.

The definition of “transfer learning” given just above encompasses many different transfer learning scenarios. For example, the source domains can differ from the target domain by having a different feature space, a different distribution of instances in the feature space, or both. Further, the source tasks can differ from the target task by having a different label space, a different predictive function for labels in that label space, or both.

In general, transfer learning is based on an assumption that there exists some relationship between the source and the target. However, with activity learning, as described herein, differences between source and target sensor modalities challenge that assumption. For example, most activity learning techniques are too sensor-specific to be generally applicable to any sensor modality other than that for which they have been designed. Furthermore, while some transfer learning techniques attempt to share information between different domains, they maintain an assumption that the source and target have the same feature space.

In contrast, as used herein, “heterogeneous transfer learning” addresses transfer learning between a source domain and a target domain when the source and target have different features spaces. Given a set of source domains DS=Dₛ_{₁}, . . . , Dₛ_{ₙ}where n>0, a target domain Dₜ, a set of source tasks TS=Tₛ_{₁}, . . . ,Tₛ_{ₙ} where Tₛ_{ᵢ} ∈ TS corresponds with Dₛ_{ᵢ} ∈ DS, and a target task Tₜ which corresponds to Dₜ, transfer learning improves the learning of the target predictive function fₜ( ) in Dₜ where Xₜ ∩ (Xₛ_{₁} ∪ . . . Xₛ_{ₙ})=0.

The heterogeneous transfer learning techniques described herein provide for transferring knowledge between heterogeneous feature spaces, with or without labeled data in the target domain. Specifically, described below is a personalized ecosystem (PECO) algorithm that enables transfer of information from an existing sensor platform to a new, different sensor platform, and also enables a colleague model in which each of the domains improves the performance of the other domains through information collaboration.

Through continuing advances in ubiquitous computing, new sensing and data processing capabilities are being introduced, enhanced, miniaturized, and embedded into various objects. The PECO algorithm described herein provides an extensible algorithm that can support additional, even yet to be developed, sensor modalities.

### Multi-View Learning

Multi-view learning techniques are used to transfer knowledge between heterogeneous activity recognition systems. The goal is to increase the accuracy of the collaborative system while decreasing the amount of labeled data that is necessary to train the system. Multi-view learning algorithms represent instances using multiple distinct feature sets or views. In an example implementation, a relationship between the views can be used to align the feature spaces using methods such as, for example, Canonical Correlation Analysis, Manifold Alignment, or Manifold Co-Regularization. Alternatively, multiple classifiers can be trained, one for each view, and the labels can be propagated between views using, for example, a Co-Training or Co-EM algorithm. Multi-view learning can be classified as “informed” or “uninformed,” depending on the availability of labeled data in the target space.

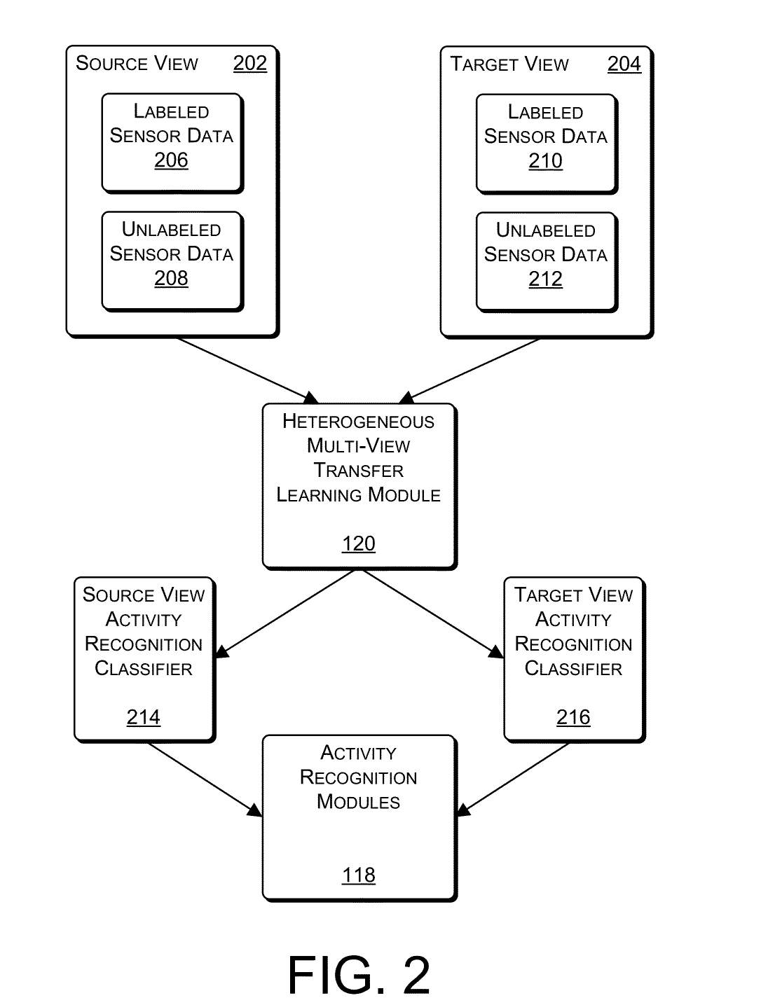

FIG. 2 illustrates an example of informed multi-view learning. The illustrated example includes a source view 202 and a target view 204. The source view 202 includes labeled sensor data 206 and unlabeled sensor data 208. Similarly, the target view 204 also incudes labeled sensor data 210 and unlabeled sensor data 212.

As indicated by the arrows in FIG. 2, heterogeneous multi-view transfer learning module 120 receives the labeled sensor data 206 and 210 and the unlabeled sensor data 208 and 212 from source view 202 and target view 204, respectively. Heterogeneous multi-view transfer learning module 120 applies a multi-view transfer learning algorithm, resulting in a trained source view activity recognition classifier 214 and a trained target view activity recognition classifier 216, which are then used by activity recognition modules 118 to recognize activities based on sensor data received in association with the source view 202 and/or the target view 204. In an example implementation, one or more of source view activity recognition classifier 214 and/or target view activity recognition classifier 216 may already exist prior to the heterogeneous multi-view transfer learning module executing a transfer learning algorithm. For example, source view 202 may have an established activity recognition model, including a source view activity recognition classifier, prior to the multi-view transfer learning process. In this scenario, source view activity recognition classifier 214 may be re-trained as part of the multi-view transfer learning process.

Upon completion of the multi-view transfer learning process, activity recognition modules 118 can use the source view activity recognition classifier 214 to label the unlabeled sensor data associated with the source view 208. Similarly, activity recognition modules 118 can use the target view activity recognition classifier 216 to label the unlabeled sensor data associated with the target view 212.

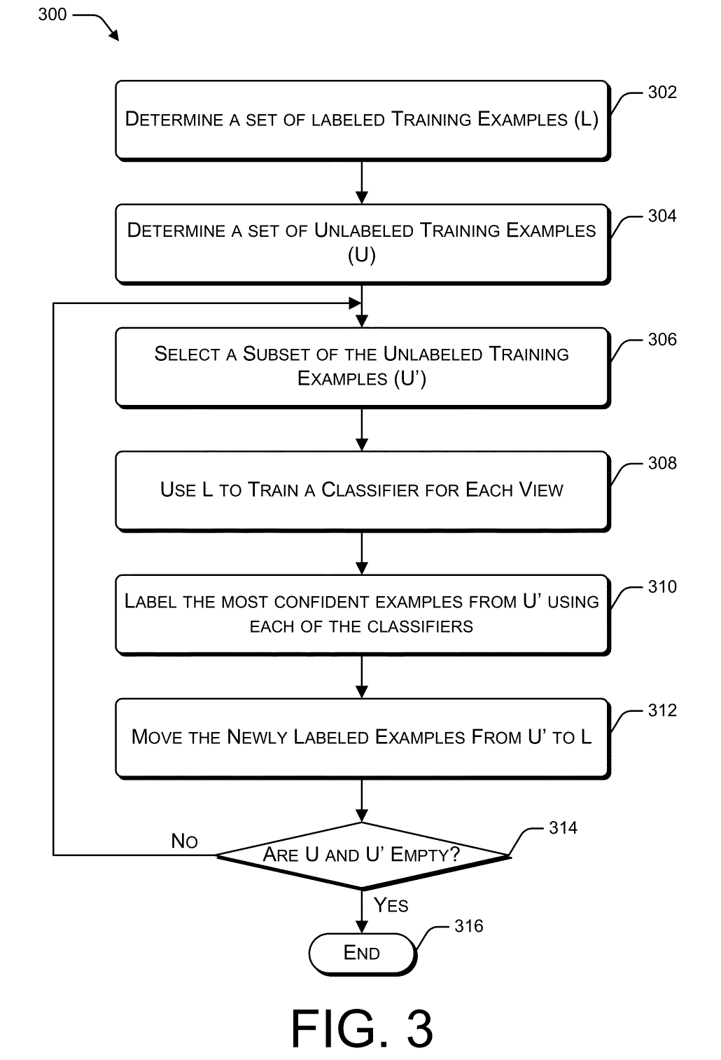

FIG. 3 illustrates an example flow diagram 300 for a Co-Training informed multi-view learning algorithm. This process is illustrated as a collection of blocks in a logical flow graph, which represents a sequence of operations that can be implemented in hardware, software, or a combination thereof. In the context of software, the blocks represent computer-executable instructions stored on one or more computer storage media that, when executed by one or more processors, cause the processors to perform the recited operations. Note that the order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, while this process is described with reference to the computing device 108 described above with reference to FIG. 1, other computer architectures may implement one or more portions of this process, in whole or in part.

At block 302, a set of labeled training examples L is determined For example, heterogeneous multi-view transfer learning module 120 receives labeled sensor data 206 from source view 202 and labeled sensor data 210 from target view 204.

At block 304, a set of unlabeled training examples U is determined For example, heterogeneous multi-view transfer learning module 120 receives unlabeled sensor data 208 from source view 202 and unlabeled sensor data 212 from target view 204.

At block 306, a subset U′ of the unlabeled training examples is selected from U. For example, heterogeneous multi-view transfer learning module 120 can randomly select a portion of the received unlabeled sensor data to be used as U′.

At block 308, L is used to train a classifier for each view. For example, if there are k views, L is used to train classifier h₁ for view 1; L is used to train classifier h₂ for view 2; . . . ; and L is used to train classifier hₖ for view k. As an example, referring to FIG. 2, labeled sensor data 206 and labeled sensor data 210 are used to train source view activity recognition classifier 214 and target view activity recognition classifier 216.

At block 310, each classifier is used to label the most confident examples from U′. For example, each classifier may be used to consider a single target activity, and label the p most confident positive examples and the n most confident negative examples, where a positive example is a data point that belongs to the target activity and a negative example is a data point that does not belong to the target activity. In an alternate example, each classifier may be used to consider a larger number of possible target activities. In this example each classifier may be configured to label only the p most confident positive examples. The Co-Training algorithm illustrated and described with reference to FIG. 3 illustrates a binary classification task (e.g., each data point is either positive or negative with regard to a single target activity), but easily extends to k-ary classification problems by allowing each classifier to label n positive examples for each class (e.g., each of multiple target activities) instead of labeling p positive examples and n negative examples for a single target activity.

At block 312, the newly labeled examples are moved from U′ to L. For example, the p most confident positive examples labeled by h₁ are removed from U′ (and U), and added to L, as labeled examples; the p most confident positive examples labeled by h₂ are removed from U′ (and U), and added to L, as labeled examples; . . . ; and the p most confident positive examples labeled by hₖ are removed from U′ (and U), and added to L, as labeled examples.

At block 314, it is determined whether or not U and U′ are now empty. In other words, have all of the unlabeled examples been labeled? If all of the unlabeled examples have been labeled (the “Yes” branch from block 314), then the process ends at block 316.

On the other hand, if there remain unlabeled examples (the “No” branch from block 314), then processing continues as described above with reference to block 306. For example, each of the classifiers 214 and 216 are iteratively re-trained based on the increasingly larger set of labeled sensor data. On this and subsequent iterations, in an example implementation, U′ may be replenished with k*p or (k*p)+(k*n) examples selected from U.

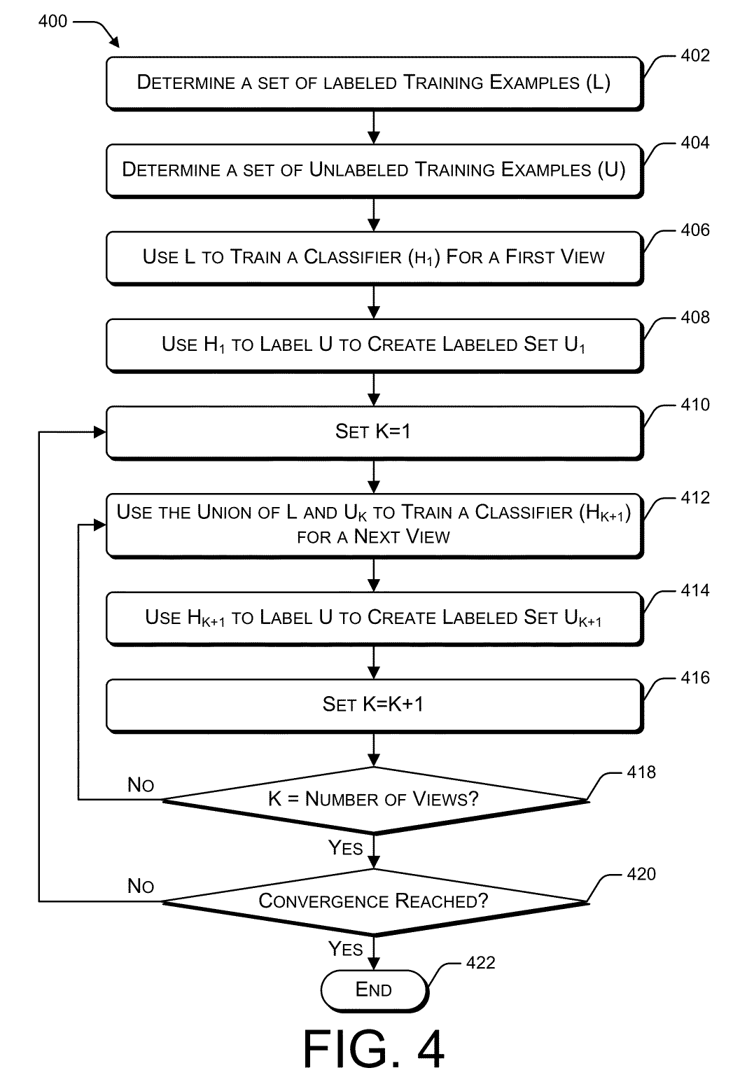

FIG. 4 illustrates an example flow diagram for a Co-EM informed multi-view learning algorithm. This process is illustrated as a collection of blocks in a logical flow graph, which represents a sequence of operations that can be implemented in hardware, software, or a combination thereof. In the context of software, the blocks represent computer-executable instructions stored on one or more computer storage media that, when executed by one or more processors, cause the processors to perform the recited operations. Note that the order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, while this process is described with reference to the computing device 108 described above with reference to FIG. 1, other computer architectures may implement one or more portions of this process, in whole or in part.

At block 402, a set of labeled training examples L is determined For example, heterogeneous multi-view transfer learning module 120 receives labeled sensor data 206 from source view 202 and labeled sensor data 210 from target view 204.

At block 404, a set of unlabeled training examples U is determined For example, heterogeneous multi-view transfer learning module 120 receives unlabeled sensor data 208 from source view 202 and unlabeled sensor data 212 from target view 204.

At block 406, L is used to train a classifier h₁ for a first view. For example, heterogeneous multi-view transfer learning module 120 uses labeled sensor data 206 and labeled sensor data 210 to train source view activity recognition classifier 214.

At block 408, h₁ is used to label U, creating a labeled set U₁. For example, heterogeneous multi-view transfer learning module 120 uses source view activity recognition classifier 214 to label unlabeled sensor data 208 and unlabeled sensor data 212. In this example, heterogeneous multi-view transfer learning module 120 leverages activity recognition modules 118 to label the unlabeled data.

Blocks 410-418 illustrate an iterative loop for training classifiers and labeling data for each of a plurality of views. At block 410, a loop variable k is initialized to one.

At block 412, the union of L and Uₖ is used to train a classifier hₖ₊₁ for a next view. For example, on the first iteration through the loop represented by blocks 410-418, at block 412, the union of L and U₁ is used to train a classifier h₂ for a second view. Similarly, on a third iteration through the loop represented by blocks 410-418, at block 412, the union of L and U₂ is used to train a classifier h₃ for a third view, and so on.

As an example, referring to FIG. 2, after using source view activity recognition classifier 214 to label unlabeled sensor data 208 and unlabeled sensor data 212, the newly labeled data is combined with labeled sensor data 206 and labeled data 210. Heterogeneous multi-view transfer learning module 120 then uses the combined labeled sensor data to train target view activity recognition classifier 216.

At block 414, classifier hₖ₋₁ is used to label U, creating a labeled set Uₖ₊₁. For example, on the first iteration through the loop, when k equals one, classifier h₂ is used to create labeled set U₂. Similarly, on a second iteration through the loop, when k equals two, classifier h₃ is used to create labeled set U₃, and so on.

For example, referring to FIG. 2, heterogeneous multi-view transfer learning module 120 uses target view activity recognition classifier 216 to label unlabeled sensor data 208 and unlabeled sensor data 212.

At block 416, the value of k is incremented by one.

At block 418, a determination is made as to whether or not k is equal to the number of views. If additional views remain (the “No” branch from block 418), then the loop repeats beginning as described above with reference to block 412. For example, although FIG. 2 illustrates only a single source view, as described above, multiple source views may be used to train a target view.

On the other hand, if a classifier has been trained and unlabeled data has been labeled for each view (the “Yes” branch from block 418), then at block 420 a determination is made as to whether or not convergence has been reached. In an example implementation, convergence is measured based on a number of labels that change across the multiple views with each iteration. In addition to checking for convergence, or instead of checking for convergence, a fixed or maximum number of iterations may be enforced.

If convergence (or a fixed or maximum number of iterations) has been reached (the “Yes” branch from block 420), then the process terminates at block 422. If convergence (or the fixed or maximum number of iterations) has not been reached (the “No” branch from block 420), then the processes continues as described above with reference to block 410.

In contrast to informed multi-view learning, uninformed multi-view learning occurs when there is no labeled training data available for the target domain, as would be the case when a new sensor platform initially becomes available.

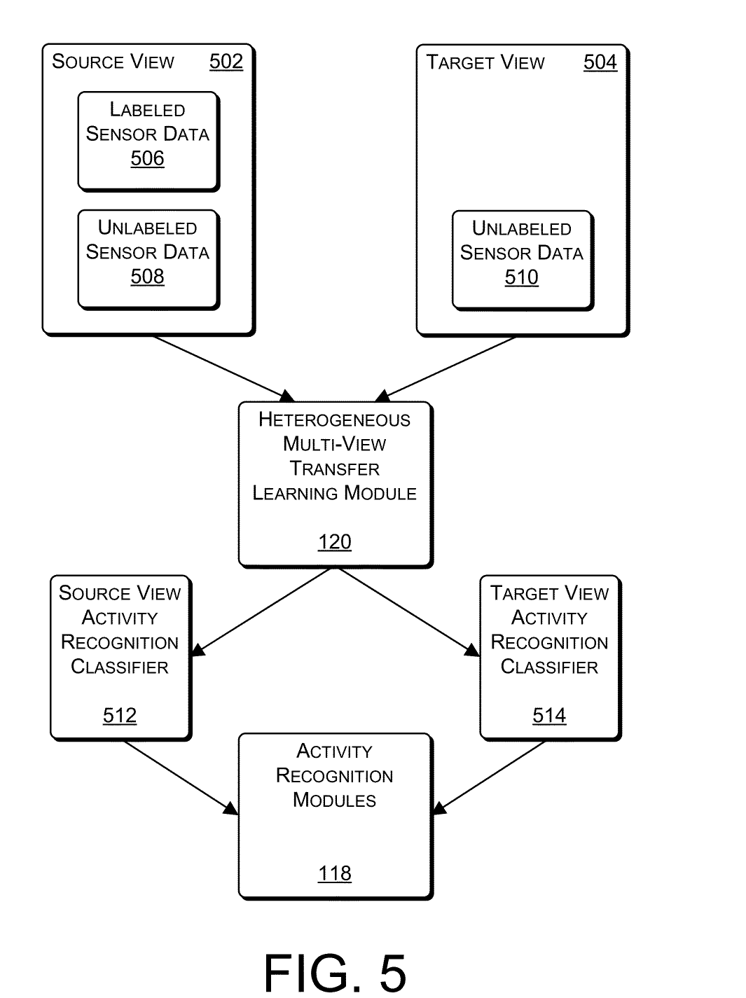

FIG. 5 illustrates an example of uninformed multi-view learning. The illustrated example includes a source view 502 and a target view 504. The source view 502 includes labeled sensor data 506 and unlabeled sensor data 508. The target view 504 also incudes unlabeled sensor data 210, but in contrast to informed multi-view learning, target view 504 does not include labeled sensor data.

As indicated by the arrows in FIG. 5, heterogeneous multi-view transfer learning module 120 receives the labeled sensor data 506 and the unlabeled sensor data 508 and 510 from source view 502 and target view 504, respectively. Heterogeneous multi-view transfer learning module 120 applies a multi-view transfer learning algorithm, resulting in a trained source view activity recognition classifier 512 and a trained target view activity recognition classifier 216, which are then used by activity recognition modules 118 to recognize activities based on sensor data received in association with the source view 502 and/or the target view 504. In an example implementation, one or more of source view activity recognition classifier 512 and/or target view activity recognition classifier 514 may already exist prior to the heterogeneous multi-view transfer learning module executing a transfer learning algorithm. For example, source view 502 may have an established activity recognition model, including a source view activity recognition classifier, prior to the multi-view transfer learning process. In this scenario, source view activity recognition classifier 512 may be re-trained as part of the multi-view transfer learning process.

Upon completion of multi-view transfer learning process, activity recognition modules 118 can use source view activity recognition classifier 512 to label the unlabeled sensor data 508 associated with the source view 502. Similarly, activity recognition modules 118 can use target view activity recognition classifier 514 to label the unlabeled sensor data 510 associated with the target view 504.

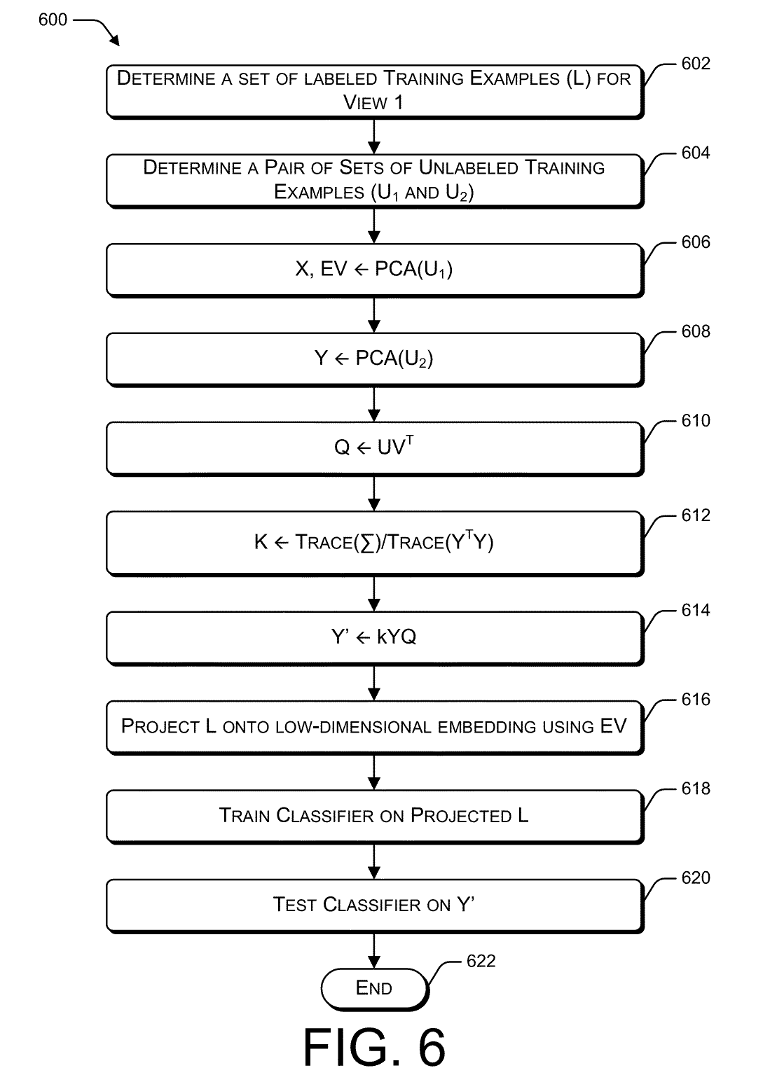

FIG. 6 illustrates an example flow diagram for a Manifold Alignment uninformed multi-view learning algorithm. The algorithm assumes that the data from each of two views share a common latent manifold, which exists in a lower-dimensional subspace. The two feature spaces are projected onto a lower-dimensional subspace, and the pairing between views is then used to align the subspace projections onto the latent manifold using a technique such as Procrustes analysis. A classifier can then be trained using projected data from the source view and tested on projected data from the target view.

This process is illustrated as a collection of blocks in a logical flow graph, which represents a sequence of operations that can be implemented in hardware, software, or a combination thereof. In the context of software, the blocks represent computer-executable instructions stored on one or more computer storage media that, when executed by one or more processors, cause the processors to perform the recited operations. Note that the order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, while this process is described with reference to the computing device 108 described above with reference to FIG. 1, other computer architectures may implement one or more portions of this process, in whole or in part.

At block 602, a set of labeled training examples L are determined from view 1. For example, referring to FIG. 5, heterogeneous multi-view transfer learning module 120 receives labeled sensor data 506.

At block 604, a pair of sets of unlabeled training examples, U₁ from view 1 and U₂ from view 2, are determined For example, heterogeneous multi-view transfer learning module 120 receives unlabeled sensor data 508 (U₁) from source view 502 and unlabeled sensor data 510 (U₂) from target view 504.

At block 606, Principal Component Analysis is applied to the unlabeled data U₁ to map the original feature vectors describing the sensor data to lower-dimensional feature vectors describing the same sensor data.

At block 608, Principal Component Analysis (PCA) is applied to the unlabeled data U₂.

Blocks 610-614 represent a manifold alignment process that maps both views to a lower-dimensionality space using PCA , and then uses Procrustes Analysis to align the two lower-dimensionality spaces.

At block 616, the original data from view 1 is mapped onto the feature vector in the lower-dimensional, aligned space.

At block 618, an activity recognition classifier is trained on the projected L (e.g., using the data that was mapped at block 616).

At block 620, the classifier is tested on Y′. For example, the classifier can be used to generate labels for data points that were not used to train the classifier (e.g, not part of L) and for which true labels are known.

The process terminates at block 622.

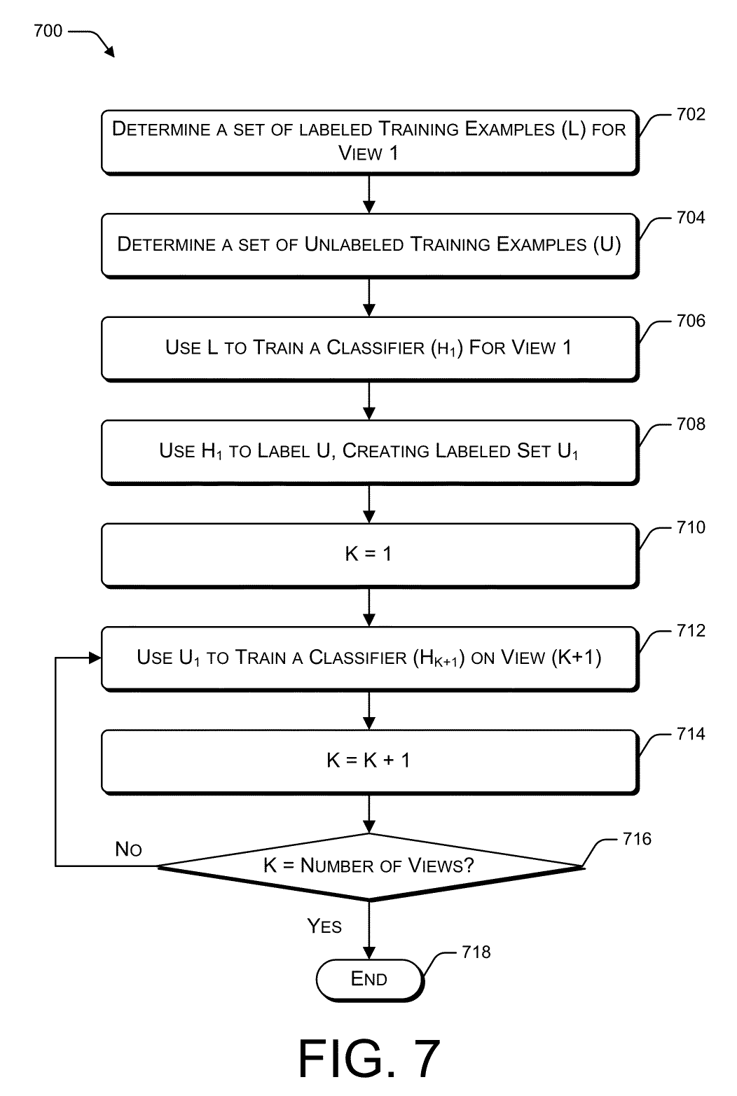

FIG. 7 illustrates an example flow diagram 700 for a teacher-learner uninformed multi-view learning algorithm. This process is illustrated as a collection of blocks in a logical flow graph, which represents a sequence of operations that can be implemented in hardware, software, or a combination thereof. In the context of software, the blocks represent computer-executable instructions stored on one or more computer storage media that, when executed by one or more processors, cause the processors to perform the recited operations. Note that the order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, while this process is described with reference to the computing device 108 described above with reference to FIG. 1, other computer architectures may implement one or more portions of this process, in whole or in part.

At block 702, a set of labeled training examples L is determined for view 1. For example, referring to FIG. 5, heterogeneous multi-view transfer learning module 120 receives labeled sensor data 506.

At block 704, a set of unlabeled training examples U is determined For example, heterogeneous multi-view transfer learning module 120 receives unlabeled sensor data 508 from source view 502 and unlabeled sensor data 510 from target view 504.

At block 706, L is used to train a classifier h₁ for view 1. For example, heterogeneous multi-view transfer learning module 120 uses labeled sensor data 506 to train source view activity recognition classifier 512.

At block 708, h₁ is used to label U, creating a new set of labeled data U₁. For example, source view activity recognition classifier 512 is used to label unlabeled sensor data 508 and unlabeled sensor data 510.

Blocks 710-716 illustrate an iterative process for training a classifier for each view. At block 710, a counter variable k is initialized to one.

At block 712, U₁ is used to train a classifier hₖ₊₁ on view k+1. For example, on the first iteration, when k=1, U₁ is used to train a classifier h₂ on view 2; on a second iteration, when k=2, U₁ is used to train a classifier h₃ on view 3; and so on.

As an example, referring to FIG. 5, heterogeneous multi-view transfer learning module 120 uses the newly labeled sensor data resulting from block 708 to train target view activity recognition classifier 514.

At block 714, k is incremented by one.

At block 716, it is determined whether or not k is equal to the total number of views. If there are additional views remaining for which a classifier has not yet been trained (the “No” branch from block 716), then processing continues as described above with reference to block 712. For example, as discussed above, multiple source views may be included in the multi-view learning algorithm.

On the other hand, if a classifier has been trained for each view (the “Yes” branch from block 716), then the process terminates at block 718.

### Personalized Ecosystem (PECO) Algorithm

As shown above, Co-Training and Co-EM benefit from an iterative approach to transfer learning when training data is available in the target space. The described Manifold Alignment algorithm and the teacher-learner algorithm benefit from using teacher-provided labels for new sensor platforms with no labeled data.

Example personalized ecosystem (PECO) algorithms, described below, combine the complementary strategies described above, which increases the accuracy of the learner without requiring that any labeled data be available. Furthermore, the accuracy of the teacher can be improved by making use of the features offered in a learner's sensor space.

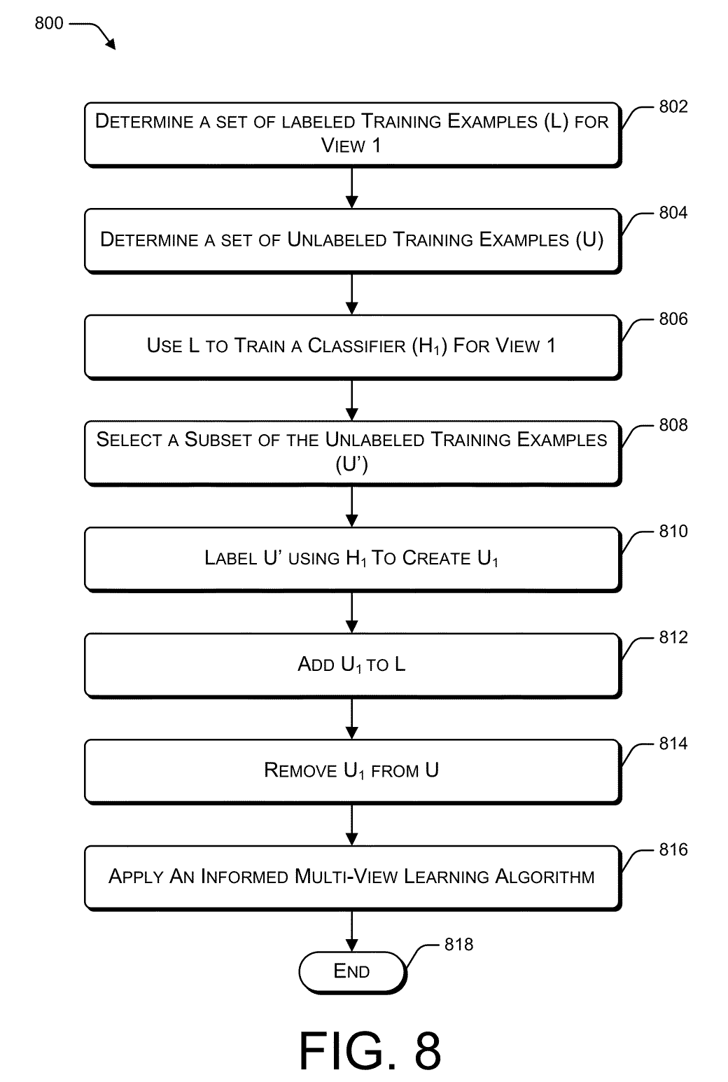

FIG. 8 illustrates an example flow diagram 800 for the PECO multi-view learning algorithm. This process is illustrated as a collection of blocks in a logical flow graph, which represents a sequence of operations that can be implemented in hardware, software, or a combination thereof. In the context of software, the blocks represent computer-executable instructions stored on one or more computer storage media that, when executed by one or more processors, cause the processors to perform the recited operations. Note that the order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, while this process is described with reference to the computing device 108 described above with reference to FIG. 1, other computer architectures may implement one or more portions of this process, in whole or in part.

At block 802, a set of labeled training examples L is determined for view 1. For example, referring to FIG. 5, heterogeneous multi-view transfer learning module 120 receives labeled sensor data 506.

At block 804, a set of unlabeled training examples U is determined For example, heterogeneous multi-view transfer learning module 120 receives unlabeled sensor data 508 from source view 502 and unlabeled sensor data 510 from target view 504.

At block 806, L is used to train a classifier h₁ for view 1. For example, heterogeneous multi-view transfer learning module 120 uses labeled sensor data 506 to train source view activity recognition classifier 512.

At block 808, a subset U′ of the unlabeled training examples is selected from U. For example, heterogeneous multi-view transfer learning module 120 can randomly select a portion of the received unlabeled sensor data to be used as U′.

At block 810, h₁ is used to label U′, creating a new set of labeled data, U₁. For example, source view activity recognition classifier 512 is used to label the subset of unlabeled data.

At block 812, the newly labeled data, U₁, is added to the received labeled data, L.

At block 814, the newly labeled data, U₁, is removed from the set of unlabeled data, U.

At block 816, an informed multi-view learning algorithm is applied, using the union of L and U₁, from block 812 as the labeled training examples, and using the result of block 814 as the unlabeled training data. In an example implementation, a Co-Training algorithm, as described above with reference to FIG. 3 may be used. In another example implementation, a Co-EM algorithm, as described above with reference to FIG. 4 may be used.

### Example Computing Device

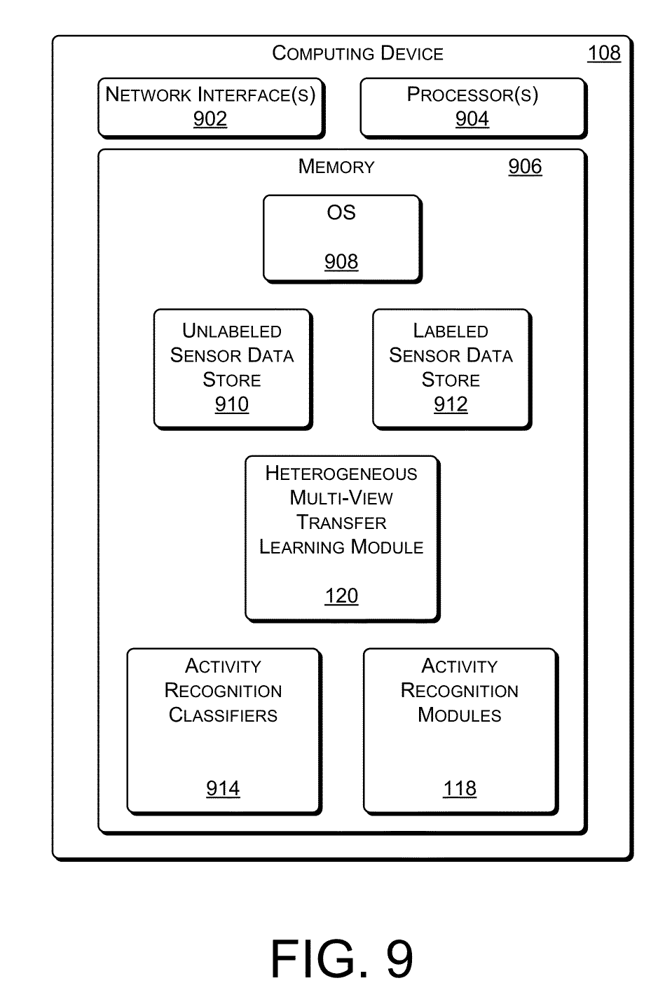

FIG. 9 illustrates an example computing device 108 for implementing collegial activity learning between heterogeneous sensors as described herein.

Example computing device 108 includes network interface(s) 902, processor(s) 904, and memory 906. Network interface(s) 902 enable computing device 108 to receive and/or send data over a network, for example, as illustrated and described above with reference to FIG. 1. Processor(s) 904 are configured to execute computer-readable instructions to perform various operations. Computer-readable instructions that may be executed by the processor(s) 904 are maintained in memory 906, for example, as various software modules.

In an example implementation, memory 906 may maintain any combination or subset of components including, but not limited to, operating system 908, unlabeled sensor data store 910, labeled sensor data store 912, heterogeneous multi-view transfer learning module 120, activity recognition modules 118, and activity recognition classifiers 914. Unlabeled sensor data store 910 may be implemented to store data that is received from one or more sensors, such as, for example, sensor events 112 received from smart home 102, sensor events 114 received from smart phone 104, and other sensor events 116. Labeled sensor data store 912 may be implemented to store labeled sensor data, for example, after activity recognition has been performed by activity recognition modules 118.

Example activity recognition modules 118 include models for analyzing received sensor data to identify activities that have been performed by an individual. Activity recognition classifiers 914 include, for example, source view activity recognition classifiers 214 and 512, target view activity recognition classifiers 216 and 514.

Heterogeneous multi-view transfer learning module 120 is configured to apply a multi-view transfer learning algorithm to train activity recognition classifiers based on received labeled and unlabeled sensor data. The algorithms described above with reference to FIGS. 3, 4, and 6-8 are examples of multi-view transfer learning algorithms that may be implemented within heterogeneous multi-view transfer learning module 120.

### Conclusion

Although the subject matter has been described in language specific to structural features and/or methodological operations, it is to be understood that the subject matter defined in the appended claims is not necessarily limited to the specific features or operations described. Rather, the specific features and acts are disclosed as example forms of implementing the claims

What is claimed is:

1. A method comprising:
identifying labeled sensor data and unlabeled sensor data associated with a source view;
identifying unlabeled sensor data associated with a target view;
combining the unlabeled sensor data associated with the source view with the unlabeled sensor data associated with the target view to create a first set of unlabeled sensor data;
training a first activity recognition classifier based at least in part on the labeled sensor data associated with the source view, the first activity recognition classifier being associated with the source view;
selecting a subset of unlabeled sensor data from the first set of unlabeled sensor data;
labeling the subset of unlabeled sensor data, using the first activity recognition classifier, to create a set of newly labeled sensor data;
defining a first set of labeled sensor data as a union of the labeled sensor data associated with the source view and the set of newly labeled sensor data;
removing the set of newly labeled sensor data from the first set of unlabeled sensor data to create a second set of unlabeled sensor data;
training the first activity recognition classifier associated with the source view and a second activity recognition classifier associated with the target view by applying an informed multi-view learning algorithm using the first set of labeled sensor data and the second set of unlabeled sensor data as input to the informed multi-view learning algorithm;
using the first activity recognition classifier that is trained by applying the informed multi-view learning algorithm to recognize activities based at least in part on sensor data received from the source view; and
using the second activity recognition classifier that is trained by applying the informed multi-view learning algorithm to recognize activities based at least in part on sensor data received from the target view.

2. A method as recited in claim 1, wherein:
the source view comprises one or more sensors having a first sensor modality; and
the target view comprises one or more sensors having a second sensor modality.

3. A method as recited in claim 1, wherein selecting the subset of unlabeled sensor data from the first set of unlabeled sensor data includes randomly selecting the subset of unlabeled sensor data.

4. A method as recited in claim 1, wherein applying an informed multi-view learning algorithm using the first set of labeled sensor data and the second set of unlabeled sensor data as input to the informed multi-view learning algorithm comprises:
training the first activity recognition classifier and the second activity recognition classifier based at least in part on the first set of labeled sensor data;
labeling at least a subset of the second set of unlabeled sensor data, using the first activity recognition classifier, to create a second set of labeled sensor data;
labeling at least a subset of the second set of unlabeled sensor data, using the second activity recognition classifier, to create a third set of labeled sensor data;
adding the second set of labeled sensor data and the third set of labeled sensor data to the first set of labeled sensor data;
removing the second set of labeled sensor data and the third set of labeled sensor data from the set of unlabeled sensor data; and
repeating the training, the labeling using the first activity recognition classifier, the labeling using the second activity recognition classifier, the adding, and the removing until a number of unlabeled sensor data remaining in the set of unlabeled sensor data is below a threshold.

5. A method as recited in claim 4, wherein the set of unlabeled sensor data is below a threshold when no unlabeled sensor data remains.

6. A method as recited in claim 1, wherein applying an informed multi-view learning algorithm using the first set of labeled sensor data and the second set of unlabeled sensor data as input to the informed multi-view learning algorithm comprises:
training the first activity recognition classifier based at least in part on the first set of labeled sensor data;
labeling the second set of unlabeled sensor data, using the first activity recognition classifier, to create a second set of labeled sensor data;
defining a third set of labeled sensor data as a union of the first set of labeled sensor data and the second set of labeled sensor data; and
training the second activity recognition classifier based at least in part on the third set of labeled sensor data.

7. A method as recited in claim 6, wherein the source view is a first source view of a plurality of source views, the method further comprising:
identifying labeled sensor data and unlabeled sensor data associated with a second source view of the plurality of source views;
combining the labeled sensor data associated with the second source view with the labeled sensor data associated with the first source view and the labeled sensor data associated with the target view to create the first set of labeled sensor data;
combining the unlabeled sensor data associated with the second source view with the unlabeled sensor data associated with the first source view and the unlabeled sensor data associated with the target view to create the first set of unlabeled sensor data;
labeling the second set of unlabeled sensor data, using the second activity recognition classifier, to create a fourth set of labeled sensor data;
defining a fifth set of labeled sensor data as a union of the first set of labeled sensor data and the fourth set of labeled sensor data;
training a third activity recognition classifier based at least in part on the fifth set of labeled sensor data, the third activity recognition classifier being associated with the second source view; and
using the third activity recognition classifier to recognize activities based on sensor data received from the second source view.

8. A method comprising:
receiving labeled data and unlabeled data associated with each of one or more source views;
receiving unlabeled data associated with a target view;
training a classifier based on the labeled data;
combining the unlabeled data associated with the source views with the unlabeled data associated with the target view to form a set of unlabeled data;
label a subset of the set of unlabeled data to create a labeled subset;
add the labeled subset to the labeled data to form an input set of labeled data;
remove the labeled subset from the set of unlabeled data to form an input set of unlabeled data;
apply an informed multi-view learning algorithm to the input set of labeled data and the input set of unlabeled data to train a classifier for each source view of the one or more source views and to train a classifier for the target view;
use the classifier for the target view to label data associated with the target view.

9. A method as recited in claim 8, wherein:
each source view comprises one or more sensors;
the target view comprises one or more sensors;
the labeled data comprises labeled sensor data from individual sensors of the one or more sensors associated with the source views; and
the unlabeled data associated with the source views comprises unlabeled sensor data from individual sensors of the one or more sensors associated with the source views; and
the unlabeled data associated with the target view comprises unlabeled sensor data from individual sensors of the one or more sensors associated with the target view.

10. A method as recited in claim 9, wherein:
the one or more sensors associated with a first source have a first sensor modality; and
the one or more sensors associated with the target have a second sensor modality;
the first sensor modality is different from the second sensor modality.

11. A method as recited in claim 8, wherein the classifier is an activity recognition classifier.

12. A method comprising:
identifying labeled data and unlabeled data associated with a source view;
identifying unlabeled data associated with a target view;
combining the unlabeled data associated with the source view with the unlabeled data associated with the target view to create a set of unlabeled data;
training a first classifier associated with the source view based on the labeled data associated with the source view;
training a second classifier associated with the target view based on the first classifier and at least a subset of the set of unlabeled data;
recursively re-training the first classifier based at least in part on the second classifier; and
recursively re-training the second classifier based at least in part on the first classifier.

13. A method as recited in claim 12, wherein:
the source view comprises one or more sensors;
the target view comprises one or more sensors;
the labeled data comprises labeled sensor data from individual sensors of the one or more sensors associated with the source view; and
the unlabeled data associated with the source view comprises unlabeled sensor data from individual sensors of the one or more sensor associated with the source view; and
the unlabeled data associated with the target view comprises unlabeled sensor data from individual sensors of the one or more sensors associated with the target view.

14. A method as recited in claim 13, wherein:
the first classifier is configured to recognize activities based on sensor data associated with the source view; and
the second classifier is configured to recognize activities based on sensor data associated with the target view.
